(19) United States
(12) Patent Application Publication
(10) Pub. No.: US 2008/0093202 A1
(43) Pub. Date: Apr. 24, 2008

(54) Electrical contact with double-Knife coupling, particularly for disconnectors, switches or the like

(75) Inventor: Roland Alfred Di Centa, London (GB)

Correspondence Address: MODIANO & ASSOCIATI, Via Meravigli, 16, Milan, 20123, omitted

(73) Assignee: CTO SOLUTIONS INC.

(21) Appl. No.: 11/584,667

(22) Filed: Oct. 23, 2006

(51) Int. Cl. H01H 21/54

(52) U.S. Cl. 200/15

(57) ABSTRACT

Electrical contact with double-knife coupling, particularly for disconnectors, switches or the like comprising: two knives, which face each other and can move toward or away from each other; a spacer, which delimits the maximum mutual approach of the knives; elastic elements, which contrast elastically the mutual spacing of the knives; and a main contact pin; the knives can move together to pass from an active position, in which they engage the main contact pin with their mutually facing faces, to an inactive position, in which they are disengaged from the main contact pin, or viceversa; elements for indicating the degree of wear of the region of contact of the knives with the main contact pin are provided which allow to detect when the degree of wear is greater than a maximum acceptable value and requires maintenance.

The present invention relates to an electrical contact with double-knife coupling, particularly for disconnectors, switches or the like.

### BACKGROUND OF THE INVENTION

Among the various types of coupling electrical contacts used in disconnectors, switches or the like, contacts with double-knife coupling are known which are constituted substantially by two knives, which face each other, are mutually spaced and are pivoted, at one of their longitudinal ends, to a supporting structure, and can engage or disengage, by means of their opposite longitudinal end, by utilizing the possibility to rotate about their own pivoting axis, with a main contact pin, so as to close or open the electrical circuit along which the knives and the main contact pin are arranged.

Generally, in an intermediate region of the longitudinal extension of the two knives there is a spacer which delimits the maximum mutual approach of the two knives so as to allow the insertion of the main contact pin between them. Such spacer is constituted generally by the arm that connects the two knives to an actuator, the actuation whereof causes the rotation of the two knives about their pivoting axis.

In order to maintain the contact between the main contact pin and the two knives, when such knives are moved into engagement with the main contact pin, there are elastic means which act on the two knives so as to contrast elastically their mutual spacing starting from the condition of maximum approach limited by the spacer.

Such elastic means are constituted generally by two helical springs, which are fitted around a pin which passes through two aligned through holes, formed in the two knives, and is arranged so that its axis is perpendicular to the plane of arrangement of the two knives. Said pin protrudes, with two of its portions, from the faces of the two knives that lie opposite with respect to the mutually facing faces, and the two springs are fitted around these portions and are interposed between the outer face of the corresponding knife and a shoulder formed by a washer fitted around the pin.

One of the main problems of these kinds of coupling contact is detecting the state of wear of the knives. The friction of the knives against the main contact pin during engagement and disengagement with it in fact causes progressive wear of the knives, which are usually made of copper or copper alloy, and have a lower wear resistance than the main contact pin.

The presence of the spacer, which limits the possibility of mutual approach of the knives beyond a certain limit, prevent said wear from being recovered beyond this limit by the action of the elastic means, with the consequence of an electrical contact that is not fully satisfactory between the knives and the main contact pin.

In order to restore correct contact between the knives and the main contact pin, during a first maintenance intervention the knives are generally turned over, arranging so that they face each other the two faces of the knives that previously were directed away from the main contact pin and therefore are not yet worn, or, generally in a second maintenance intervention, the worn knives are replaced.

Currently commercially available electrical contacts provide no indication of the state of wear of the knives and therefore the maintenance interventions for turning over the knives or replacing them can be planned only as a function of the period of operation of the electrical contact.

This causes in practice maintenance interventions that are more frequent than actually required, with higher operating costs than strictly necessary, or on the contrary causes maintenance interventions to be less frequent than actually necessary, with the inevitable consequence of having unsatisfactory situations of contact between the knives and the main contact pin.

### SUMMARY OF THE INVENTION

The aim of the present invention is to solve the problem described above by providing an electrical contact with double-knife coupling, particularly for disconnectors, switches or the like, which allows to detect easily the state of wear of the knives so as to be able to perform the maintenance intervention that are actually required in order to ensure efficiency of the electrical contact.

Within this aim, an object of the invention is to provide an electrical contact with double-knife coupling in which the state of wear of the knives can be detected very simply even by unspecialized personnel.

Another object of the invention is to provide an electrical contact with double-knife coupling which is also very compact along a direction which is perpendicular to the planes of arrangement of the two knives.

This aim and these and other objects, which will become better apparent hereinafter, are achieved by an electrical contact with double-knife coupling, particularly for disconnectors, switches or the like, which comprises a main contact pin and two mutually facing knives which can move toward or away from each other, said knives being movable together in order to pass from an active position, in which they engage said main contact pin with their mutually facing faces, to an inactive position, in which they are disengaged from said main contact pin, or vice versa; a spacer being interposed between said knives and limiting the maximum mutual approach of said knives in order to allow the insertion of said main contact pin between said knives in their transition from said inactive position to said active position, and elastic means being provided which contrast elastically the mutual spacing of said knives starting from the condition of maximum mutual approach in order to maintain the contact of said knives, in said active position, with said main contact pin, and further comprising means for indicating the degree of wear of the region of contact of said knives with said main contact pin.

### BRIEF DESCRIPTION OF THE DRAWINGS

Further characteristics and advantages of the invention will become better apparent from the description of a preferred but not exclusive embodiment of the electrical contact according to the invention, illustrated by way of non-limiting example in the accompanying drawings, wherein:

FIG. 1 is a schematic side elevation view of the electrical contact with double-knife coupling according to the invention;

FIG. 2 is a top plan view of a detail of the electrical contact according to the invention, with knives which are not worn;

FIG. 3 is a top plan view of a detail of the electrical contact according to the invention with worn knives;

FIG. 4 is an enlarged-scale schematic sectional view of FIG. 2, taken along along the plane IV-IV;

FIG. 5 is an exploded perspective view of the elements of FIG. 4, except for the knives.

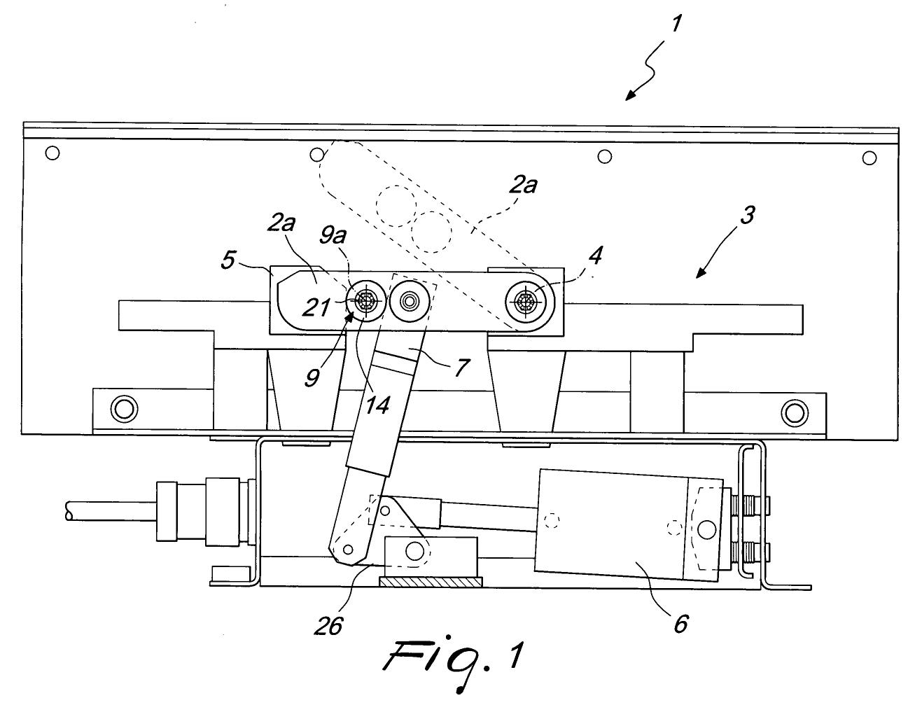

### DESCRIPTION OF THE PREFERRED EMBODIMENTS

With reference to the figures, the electrical contact with double-knife coupling according to the invention, generally designated by the reference numeral 1, comprises two knives 2a, 2b, which face each other and are preferably pivoted, at a longitudinal end thereof, to a supporting structure 3 about a pivoting axis 4.

A main contact pin 5 is fixed on the supporting structure 3 and is spaced with respect to the pivoting axis 4 so that it can be engaged or disengaged with respect to the longitudinal end of the two knives 2a, 2b that lies opposite the end that is pivoted to the supporting structure 3 as a consequence of the rotation of the knives 2a, 2b about the pivoting axis 4 with respect to the supporting structure 3.

The two knives 2a, 2b are connected, in an intermediate region of their extension which lies between the pivoting axis 4 and their end that can engage the main contact pin 5, to an actuator 6 by means of a linkage 7. The actuator 6 can be actuated in order to turn the knives 2a, 2b together about the pivoting axis 4 and therefore produce their transition from an active position, in which they engage with their mutually facing faces the main contact pin 5, to an inactive position, in which they are disengaged from the main contact pin 5, or vice versa.

A spacer is interposed between the knives 2a, 2b and is designed to limit the maximum mutual approach of the knives 2a, 2b so as to allow the insertion of the main contact pin 5 between the knives 2a, 2b when they pass from the inactive position to the active position.

The electrical contact according to the invention also comprises elastic means 8, which contrast elastically the mutual spacing of the knives 2a, 2b starting from the condition of maximum approach limited by such spacer, in order to maintain the contact of the knives 2a, 2b in the active position with the main contact pin 5.

According to the invention, the electrical contact being considered comprises means for indicating the degree of wear of the region of contact of the knives 2a, 2b with the main contact pin 5.

These means for indicating the degree of wear comprise a connecting pin, generally designated by the reference numeral 9, which mutually connects the knives 2a, 2b in a detection region, which is spaced from their region that can engage the main contact pin 5 and is arranged with its axis 9a at right angles to the mutually facing faces of the knives 2a, 2b. The knives 2a, 2b can slide along the connecting pin 9 toward each other due to the action of the elastic means 8 or away from each other due to the engagement with the main contact pin 5. An indicator 10 is fitted on the connecting pin 9 and can be locked on the connecting pin 9 due to the contact of the knives 2a, 2b against the axial ends of said indicator 10. The indicator 10 has dimensions, parallel to the axis of the connecting pin 9, which correspond to the maximum acceptable mutual approach, at the detection region, for the knives 2a, 2b when they are engaged with the main contact pin 5.

The indicator 10 is constituted preferably by a sleeve 11, which is fitted around the connecting pin 9 and is arranged so that its axial ends face the mutually facing faces of the knives 2a, 2b. The inside diameter of the sleeve 11 is greater than the outside diameter of the connecting pin 9 so as to be able to rotate freely about the connecting pin 9 when the knives 2a, 2b are disengaged from its axial ends.

Moreover, the sleeve 11 is preferably also able to slide freely along the connecting pin 9 in the absence of contact of the knives 2a, 2b with its axial ends.

The knives 2a, 2b are preferably mutually parallel and the sleeve 11 has an axial length that is equal to the dimensions of the main contact pin 5 along a direction which is perpendicular to the planes of arrangement of the knives 2a, 2b minus the acceptable wear of the knives 2a, 2b along such direction.

Preferably, the outer lateral surface of the sleeve 11 is knurled so as to facilitate the manual grip of the sleeve 11.

Conveniently, the sleeve 11 also acts as a spacer, limiting the maximum mutual approach allowed to the knives 2a, 2b when they are in the inactive position, i.e., disengaged from the main contact pin 5.

The elastic means 8 that contrast elastically the mutual spacing of the knives 2a, 2b are preferably integrated with the connecting pin 9 and are contained within the axial dimensions of the connecting pin 9.

More particularly, the connecting pin 9 passes coaxially through two through holes 12a, 12b which are formed within the knives 2a, 2b and are mutually aligned along a direction which is perpendicular to the planes of arrangement of the knives 2a, 2b.

The connecting pin 9 has, at its axial ends, two portions 13 and 14, which form two mutually opposite shoulders 13a and 14a, which engage the faces of the knives 2a, 2b that lie opposite the mutually facing faces. These two portions 13 and 14 of the connecting pin 9 can move away from each other in contrast with the action of the elastic means 8, which are contained within the axial dimensions of the connecting pin 9.

Conveniently, such elastic means 8 are arranged inside the connecting pin 9.

More particularly, the connecting pin 9 comprises a substantially cylindrical body 15, inside which a coaxial cylindrical cavity 16 is formed starting from its axial end provided with the first portion 13.

The cavity 16 is open at the longitudinal end of the body 15 that supports the first portion 13 and has, at the opposite end of the body 15, a bottom 17 which is crossed centrally by a hole 18.

The first portion 13, which forms the shoulder 13a, is constituted by a flange of the lateral surface of the body 15 at the corresponding axial end.

The second portion 14, which forms the shoulder 14a, is instead connected to a shaft 19, which is partially accommodated coaxially within the cavity 16 and protrudes, through the hole 18, from the axial end of the body 15 that lies opposite the end provided with the first portion 13.

The elastic means 8 are accommodated within the cavity 16 and are interposed between the bottom 17 of the cavity 16 and the axial end of the shaft 19 that lies opposite the axial end connected to the second portion 14. The axial end of the shaft 19 that abuts against the elastic means 8 is conveniently constituted by a head 19a, which has a larger diameter than the remaining part of the shaft 19 so as to form a shoulder against which the elastic means 8 engage.

The elastic means 8 are constituted preferably by a pack of Belleville springs 20, which are fitted around the shaft 19.

As an alternative, the elastic means 8 can be constituted, instead of by Belleville springs, by a helical spring which is fitted around the shaft 19 and is interposed between the head 19a of the shaft 19 and the bottom 17 of the cavity 16.

The second portion 14 is preferably constituted by a circular element, which is fitted on the end of the shaft 19 that protrudes from the body 15 and is locked, in the opposite direction with respect to the body 15, by means of a locking element, which contrasts the extraction of the circular element from the shaft 19 in the opposite direction with respect to the body 15. Said locking element is composed of a nut 21, which is screwed onto the axial end, which is conveniently threaded, of the shaft 19 that supports the second portion 14, and of a locking pin 22, which passes transversely through the shaft 19 and abuts against a radial seat 23 formed on the face of the nut 21 that is directed away with respect to the body 15, so as to prevent the rotation of the nut 21 with respect to the shaft 19. The nut 21 is provided with a plurality of radial seats 23, which are distributed about the axis of the shaft 19 so as to allow to lock the nut 21 in different angular positions about the axis of the shaft 19.

The nut 21 is conveniently contained within a recess 24 formed on the face of the circular element that constitutes the second portion 14, which is oriented in the opposite direction with respect to the body 15.

The circular element that constitutes the second portion 14 has, on its face directed toward the body 15, a cylindrical protrusion 25, whose diameter is equal to the outside diameter of the body 15 so as to center the second portion 14 within the hole 12a.

The actuator 6 can be an actuator of the mechanical type or an actuator of the hydraulic type, as shown, of the known type, which acts on the linkage 7, for example by means of an articulated connecting triangle 26, so as to turn through an arc of preset breadth the knives 2a, 2b about the pivoting axis 4 in order to achieve their passage from the active position to the inactive position or vice versa.

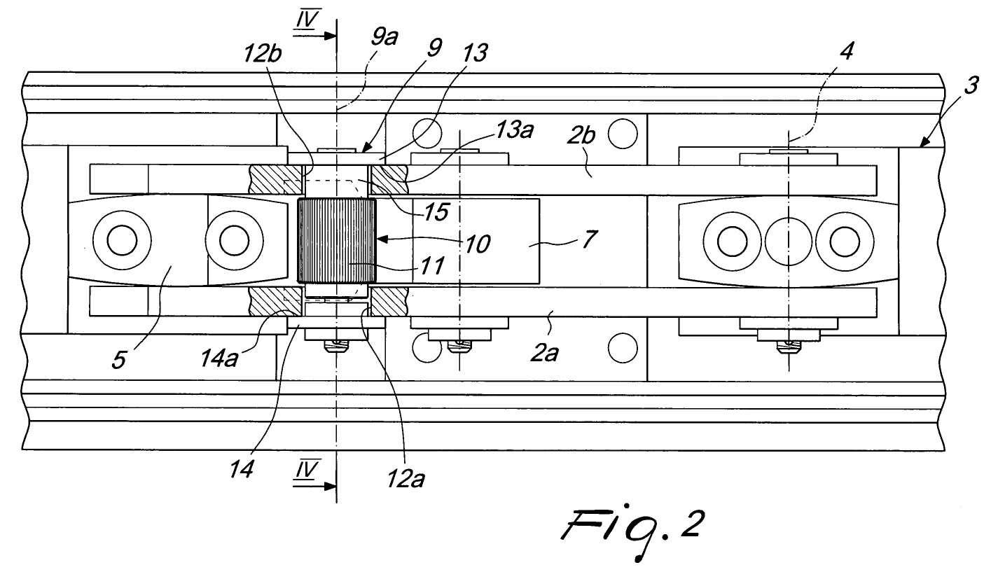

In practice, when the knives 2a, 2b are engaged with the main contact pin 5 and their degree of wear is not such as to cause their contact against the axial ends of the indicator 10 (FIG. 2), the indicator can rotate freely about its own axis with respect to the connecting pin 9. This situation of no wear or of acceptable wear can be detected easily by turning manually the indicator 10. The degree of wear of the knives 2a, 2b can also be perceived directly, simply by sliding the indicator 10 axially along the connecting pin 9 and assessing the extent of the sliding that is allowed.

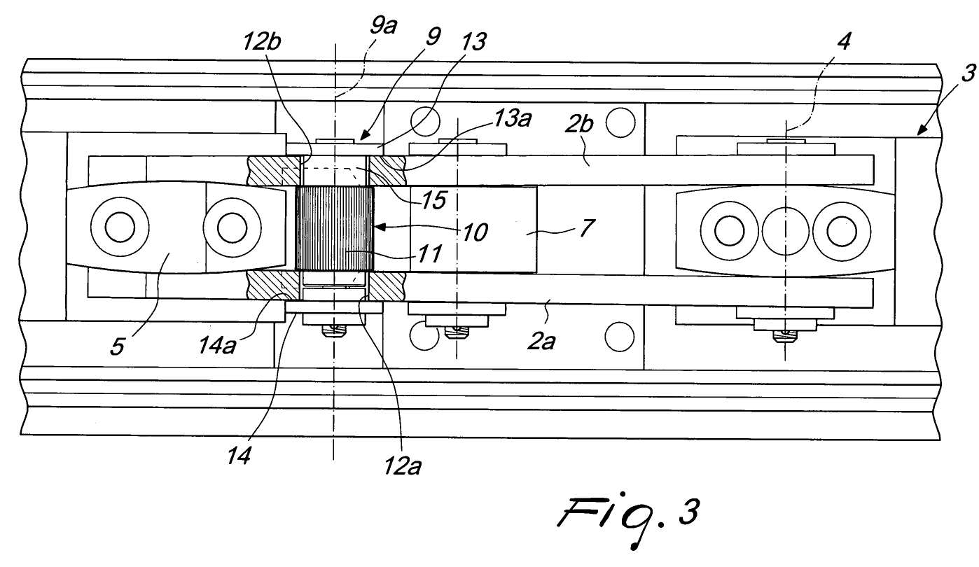

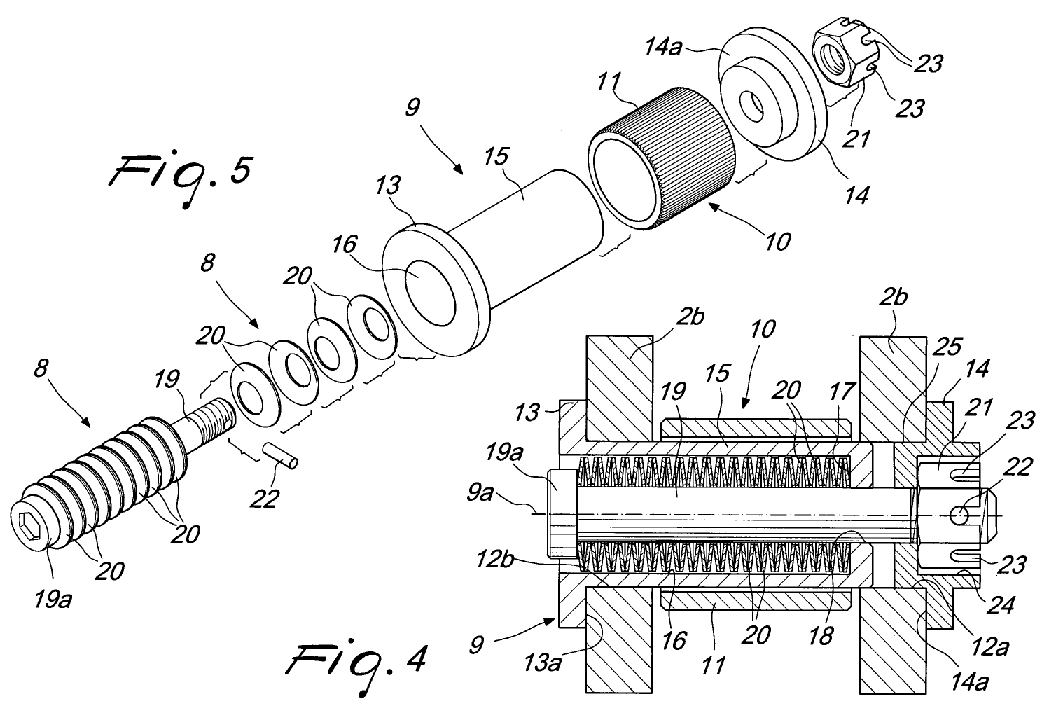

When the wear of the knives 2a, 2b engaged with the main contact pin 5 is such as to cause contact of said knives 2a, 2b against the axial ends of the indicator 10 (FIG. 3), the indicator is locked and cannot rotate with respect to the connecting pin 9. This condition of wear can be detected easily by trying to turn the indicator 10 by hand. Locking of the indicator 10 by the knives 2a, 2b when they are engaged with the main contact pin 5 indicates the need to turn over the position of the knives 2a, 2b, in order to change their faces that engage the main contact pin 5, or replace them.

In practice it has been found that the electrical contact with double-knife coupling according to the invention fully achieves the intended aim, since thanks to the presence of the means for indicating the degree of wear of the knives it allows to perform the maintenance interventions that are actually necessary in order to ensure efficiency of the electrical contact.

Another advantage consists in that since the elastic means that contrast the mutual spacing of the two knives are arranged within the axial dimensions of the connecting pin, whose dimensions are only slightly larger than the overall transverse dimensions of the knives, the electrical contact according to the invention has compact dimensions, which particularly in the provision of electrical contacts with double-knife coupling for lines having multiple electrical phases, allows to reduce the distance between the pairs of knives of the various phases, obtaining a set of electrical contacts that is extremely compact.

The electrical contact thus conceived is susceptible of numerous modifications and variations, all of which are within the scope of the appended claims; all the details may further be replaced with other technically equivalent elements.

In practice, the materials used, so long as they are compatible with the specific use, as well as the dimensions, may be any according to requirements and to the state of the art.

What is claimed is:

1. An electrical contact with double-knife coupling, particularly for disconnectors, switches or the like, comprising a main contact pin and two mutually facing knives which can move toward or away from each other, said knives being movable together in order to pass from an active position, in which they engage said main contact pin with their mutually facing faces, to an inactive position, in which they are disengaged from said main contact pin, or vice versa; a spacer being interposed between said knives and limiting the maximum mutual approach of said knives in order to allow the insertion of said main contact pin between said knives in their transition from said inactive position to said active position, and elastic means being provided which contrast elastically the mutual spacing of said knives starting from the condition of maximum mutual approach in order to maintain the contact of said knives, in said active position, with said main contact pin, and further comprising means for indicating the degree of wear of the region of contact of said knives with said main contact pin.

2. The electrical contact according to claim 1, wherein said means for indicating the degree of wear comprise a connecting pin, which mutually connects said knives in a detection region, which is spaced from their region that can engage said main contact pin, and is arranged so that its axis is perpendicular to the mutually facing faces of said knives; said knives being able to slide along said connecting pin toward each other, due to the action of said elastic means, or away from each other due to engagement with said main contact pin; an indicator being fitted on said connecting pin and being lockable on said connecting pin by the contact of said knives against the axial ends of said indicator; said indicator having dimensions, parallel to the axis of said connecting pin, which correspond to the maximum mutual acceptable approach, at said detection region, for said knives in engagement with said main contact pin.

3. The electrical contact according to claim 2, wherein said indicator comprises a sleeve, which is fitted around said connecting pin and whose axial ends face the mutually facing faces of said knives; said sleeve being able to rotate freely with respect to said connecting pin about its own axis in the absence of contact of said knives against its axial ends.

4. The electrical contact according to claim 1, wherein said knives are substantially parallel to each other and in that said sleeve has an axial length equal to the dimensions of said main contact pin along a direction which is perpendicular to the planes of arrangement of said knifes minus the acceptable wear for said knives along the same direction.

5. The electrical contact according to claim 3, wherein said spacer is constituted by said sleeve.

6. The electrical contact according to claim 3, wherein said sleeve can slide freely axially along said connecting pin in the absence of contact of said knives against its axial ends.

7. The electrical contact according to claim 3, wherein the outer lateral surface of said sleeve is knurled.

8. The electrical contact according to claim 1, wherein said connecting pin passes coaxially through two through holes, which are formed in said knives and are mutually aligned along a direction which is perpendicular to the planes of arrangement of said knives; said connecting pin having, at its axial ends, two portions which form two mutually opposite shoulders which engage the faces of said knives that lie opposite with respect to the mutually facing faces; said two portions of the connecting pin being movable away from each other in contrast with said elastic means.

9. The electrical contact according to claim 8, wherein said elastic means are contained within the axial dimensions of said connecting pin.

10. The electrical contact according to claim 8, wherein said elastic means are accommodated in said connecting pin.

11. The electrical contact according to claim 1, wherein said connecting pin comprises a substantially cylindrical body inside which there is a coaxial cylindrical cavity starting from one of its axial ends; a first one of said two portions being constituted by a flange of the lateral surface of said body at said axial end, the second of said portions being associated with a shaft which is accommodated coaxially within said cavity and protrudes from the axial end of said body that lies opposite with respect to the axial end provided with said flange, said elastic means being accommodated in said body and being interposed between the bottom of said cavity and the axial end of said shaft that lies opposite with respect to the end that supports said second portion.
